(19) United States
(12) Patent Application Publication
(10) Pub. No.: US 2003/0108351 A1
(43) Pub. Date: Jun. 12, 2003

(54) Methods for ultra long-haul optical communications

(76) Inventors: Lee Daniel Feinberg, Silver Spring, MD (US); M. Imran Hayee, Columbia, MD (US); Bo Pedersen, Annapolis, MD (US)

Correspondence Address: FOLEY AND LARDNER, SUITE 500, 3000 K STREET NW, WASHINGTON, DC, 20007, US

(21) Appl. No.: 09/960,722

(22) Filed: Sep. 24, 2001

(51) Int. Cl. H04B 10/12; H04B 10/08

(52) U.S. Cl. 398/34; 398/175; 398/141

(57) ABSTRACT

A method of providing power via a power cable to optical line units for amplification of an optical signal propagating along an optical fiber having a first end and a second end and terminated solely at the first end and the second end is provided comprising terminating the power cable at a location between a first plurality of line units and a second plurality of line units.

### BACKGROUND OF THE INVENTION

A. Field of the Invention

The invention relates generally to optical communication systems, more particularly to methods and systems for ultra-long haul optical communication systems.

B. Background of the Invention

Optical communication systems are widely used to transmit voice and/or data communications. Increasingly, optical communication systems are being used to communicate between locations separated by great distances, such as a Trans-Pacific link between the United States and China. Many technical difficulties inherent to ultra long-haul optical signal transportation must be overcome to permit optical communication between locations separated by such great distances. At the same time, market forces have pressured the price of bandwidth into a steep decline. Thus, the technical solutions provided for ultra long-haul optical communications need to be able to provide a very large amount of bandwidth at a low cost per bit. Advances in optical fibers over which optical data signals can be transmitted, as well as techniques for efficiently using the bandwidth available on such fibers, such as wavelength division multiplexing (WDM), have provided a technical framework within which to create ultra-long haul optical communication solutions. As is known in the art, WDM techniques permit a number of channels or wavelengths each of which carry an optical data stream, e.g., an OC-192 rate optical data stream, to be multiplexed together into a composite WDM optical signal for transmission over an individual optical fiber.

As an optical signal travels along the optical fiber, it attenuates. First generation long haul optical communication systems dealt with this problem by inserting regenerative repeaters along the transmission span. Regenerative repeaters convert the optical data signal into an electrical signal, reshape the electrical signal into (substantially) its originally transmitted form, reconvert it into the optical domain and forward it to the next repeater until it reaches its destination. Such regenerative repeaters were extremely complex and expensive. Moreover, these devices were typically bit rate dependent, i.e., were not amenable to upgrades that would extend the throughput capabilities of the optical communication system.

In the late 1980s/early 1990s, regenerative repeaters were replaced by optical amplifiers, i.e., devices which did not need to convert the optical signal into the electrical domain to amplify the signal. For example, erbium-doped fiber amplifiers (EDFAs) have been widely used for optical amplification in the line units of such systems. As seen in FIG. 1, an EDFA 10 employs a length of erbium-doped fiber 12 inserted between the spans of conventional fiber 14. A pump laser 16 injects a pumping signal having a wavelength of, for example, approximately 1480 nm into the erbium-doped fiber 12 via a coupler 18. This pumping signal interacts with the f-shell of the erbium atoms to stimulate energy emissions that amplify the incoming optical data signal, which has a wavelength of, for example, about 1550 nm.

A long haul optical communication system, e.g., greater than several hundred kilometers, will then have a number of optical amplifiers placed along the transmission span. For example, in the submarine optical communication system 20 shown in FIG. 2, the terrestrial signal(s) are processed in WDM terminal 22 for transmission via optical fiber 24. Periodically, e.g., every 75 km, a line unit 26 amplifies the transmitted WDM signal so that it arrives at WDM terminal 28 with sufficient signal strength (and quality) to be successfully transformed back into terrestrial signal(s).

Despite the advances made in EDFA amplification techniques, over very long distances (referred to herein as “ultra long-haul”), e.g., greater than 9000 kilometers, conventional WDM optical communication systems still require at least one instance of signal regeneration in order to provide the receiving terminal with sufficient signal quality to be reproduced. This is attributable to, among other things, accumulated non-linearity impairments generated by ultra long-haul EDFA optical communication systems. These nonlinearities, for example self-phase modulation, cross-phase modulation and four-wave mixing, create interactions between the propagating light and the medium and, generally, reduce system performance.

Accordingly, one conventional method of implementing an ultra long-haul WDM optical communication system terminates both the optical fiber(s) and associated power cable at a point between the terminals so that the optical signal can be electrically regenerated. For example, as generally shown in FIG. 3, a first optical fiber 30 links a first terminal (e.g., in California) with a termination location (e.g., Hawaii) at about a midpoint of the distance between the first location and a second location (e.g., in China). A first power cable 32 provides power to a first plurality of line units (not shown in FIG. 3) that amplify a WDM optical signal propagating along the first optical fiber 30. The termination unit 34 terminates the first optical fiber 32, converts each channel within the WDM optical signal into an electrical signal and regenerates the electrical signal. Each electrical signal is then reformatted into an optical signal, re-multiplexed into a WDM composite signal with the other wavelengths and input into a second optical fiber 36 that links the termination location with the second location. A second power cable 38 provides power to a second plurality of line units (not shown) that amplify the WDM optical signal propagating along the second optical fiber. The second optical fiber 36 is terminated at the second location, thereby completing the optical link between the first terminal 22 and the second terminal 28.

However, optical signal termination is very costly, as WDM termination equipment may be greater than $300,000 per channel. Consequently, terminating both the optical fiber and the power cable at a midpoint termination location typically cannot be implemented cost effectively on a large bandwidth system with many, e.g., 100-500, WDM channels. Accordingly, it would be desirable to design an ultra-long haul WDM optical communication system that overcomes the problems associated with conventional solutions.

### SUMMARY OF THE INVENTION

According to one aspect of the present invention, a method of transmitting an optical signal is provided comprising the steps of providing an optical signal into an optical fiber having a first end and a second end, amplifying the optical signal propagating along the optical fiber, and supplying power for amplification from a power cable having at least one end terminated between the first end and the second end of the optical fiber. Preferably, the power cable is terminated at about a midpoint of the optical fiber.

According to another aspect of the present invention, the method of transmitting an optical signal further comprises a step of monitoring optical signal quality of the optical signal propagating along the optical fiber at a site of power termination.

According to another aspect of the present invention, the method of transmitting an optical signal further comprises a step of adjusting a gain profile of the optical signal propagating along the optical fiber at a site of power termination.

According to another aspect of the present invention, the method of transmitting an optical signal further comprises the steps of filtering out at least one channel of the optical signal propagating along the optical fiber, and inserting at least one other channel of the optical signal propagating along the optical fiber. The steps of filtering out at least one channel and inserting at least one other channel are performed at a site of power termination.

According to another aspect of the present invention, the method of transmitting an optical signal further comprises a step of splitting the optical fiber into a first branch path and a second branch path at a site of power termination.

According to another aspect of the present invention, a method of providing power via a power cable to optical line units for amplification of an optical signal propagating along an optical fiber having a first end and a second end and terminated solely at the first end and the second end is provided comprising terminating at least one end of the power cable between a first plurality of line units and a second plurality of line units.

According to another aspect of the present invention, a method of transmitting an optical signal via an optical fiber having a first end and a second end is provided comprising the steps of providing an optical signal into a long-haul optical fiber terminated solely at a first end and a second end, amplifying the optical signal propagating along the optical fiber in a plurality of line units, and supplying power for amplification via a power cable to the plurality of line units. The power cable is positioned adjacent to the optical fiber, connected to the line units, and terminated at a power cable termination position located between the first end and the second end of the optical fiber. Preferably, the power cable supplies at least 10,000 watts of power to the line units.

### BRIEF DESCRIPTION OF THE DRAWINGS

The foregoing advantages and features of the invention will become apparent upon reference to the following detailed description and the accompanying drawings, of which:

FIG. 1 is a conceptual diagram of a conventional erbium-doped fiber amplifier;

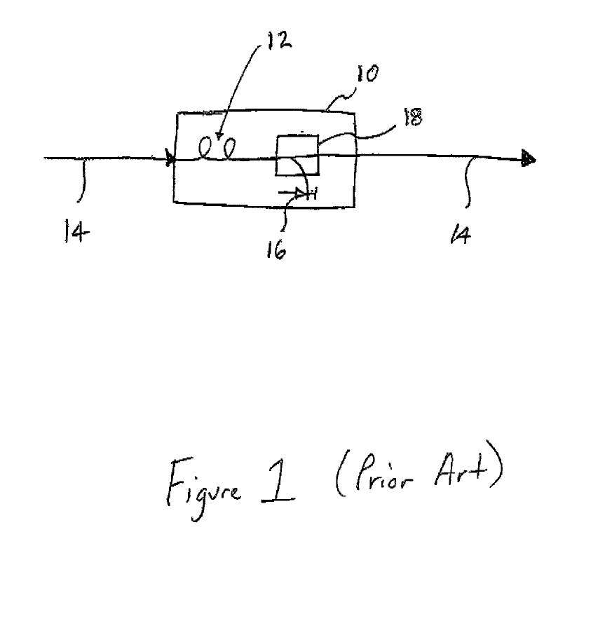

FIG. 2 is a schematic diagram of an optical communication system in which the present invention can be implemented;

FIG. 3 illustrates a conventional ultra long-haul optical communication system having optical and power lines terminated at a point between terminals;

FIG. 4 is a block diagram of an exemplary terminal unit of an optical communication system according to exemplary embodiments of the present invention;

FIG. 5 is a block diagram of an exemplary line unit of an optical communication system in which the present invention can be implemented;

FIG. 6 is another block diagram of an exemplary line unit of an optical communication system including an exemplary Raman pumping architecture;

FIG. 7 illustrates an exemplary ultra long-haul optical communication system according to the present invention having only the power cable terminated at a point between terminals;

FIG. 8 is a block diagram of a second exemplary embodiment of an optical communication system according to the present invention, with a power cable terminated between a first end and a second end of an optical fiber;

FIG. 9 is a block diagram of a third exemplary embodiment of a method of transmitting an optical signal according to the present invention, with a power cable terminated between a first end and a second end of an optical fiber;

FIG. 10 is a block diagram of a fourth exemplary embodiment of an optical communication system according to the present invention, with an optical splitter located adjacent to a site of power termination;

FIG. 11 is a block diagram of a fifth exemplary embodiment of a method of transmitting an optical signal according to the present invention with a split optical fiber and a plurality of branch paths;

FIG. 12 is a block diagram of a sixth embodiment of an optical communication system according to the present invention, with a pair of optical add/drop multiplexers (OADM) located adjacent to a site of power termination; and

FIG. 13 is a block diagram of a seventh exemplary embodiment of a method of transmitting an optical signal according to the present invention with channel filtering.

FIG. 14 is a block diagram of a sixth embodiment of an optical communication system according to the present invention, with a pair of optical add/drop multiplexers (OADM) located adjacent to a site of power termination; and

FIG. 15 is a block diagram of a seventh exemplary embodiment of a method of transmitting an optical signal according to the present invention with channel filtering.

### DETAILED DESCRIPTION

In the following description, for the purposes of explanation and not limitation, specific details are set forth, such as particular systems, networks, software, components, techniques, etc., in order to provide a thorough understanding of the present invention. However, it will be apparent to one skilled in the art that the present invention may be practiced in other embodiments that depart from these specific details. In other instances, detailed descriptions of known methods, devices and circuits are abbreviated or omitted so as not to obscure the present invention.

Distributed Raman amplification is one amplification scheme that can provide a broad and relatively flat gain profile over a wider wavelength range than that which has conventionally been used in optical communication systems employing EDFA amplification techniques. Raman amplifiers employ a phenomenon known as “stimulated Raman scattering” to amplify the transmitted optical signal. In stimulated Raman scattering radiation from a pump laser interacts with a gain medium through which the optical transmission signal passes to transfer power to that optical transmission signal. One of the benefits of Raman amplification is that the gain medium can be the optical fiber itself, i.e., doping of the gain material with a rare-earth element is not required as in EDFA techniques. The wavelength of the pump laser(s) is selected such that the vibration energy generated by the pump laser beam's interaction with the gain medium is transferred to the transmitted optical signal in a particular wavelength range, which range establishes the gain profile of the pump laser(s).

Although the ability to amplify an optical signal over a wide bandwidth makes Raman amplification an attractive option for next generation optical communication systems, the need for a relatively large number of high power pump lasers (and other components) for each amplifier in a Raman system has hitherto made EDFA amplification schemes the technology of choice for ultra long-haul optical communication systems. However, as mentioned above, optical communication systems employing EDFA amplification schemes require at least one instance of signal regeneration in ultra long-haul applications, which is quite expensive. As will be described in more detail below, Applicants have determined that Raman amplification can be used to design an ultra long-haul haul, WDM optical communication system which does not require signal regeneration, i.e., systems according to the present invention can span the Pacific Ocean without optical termination.

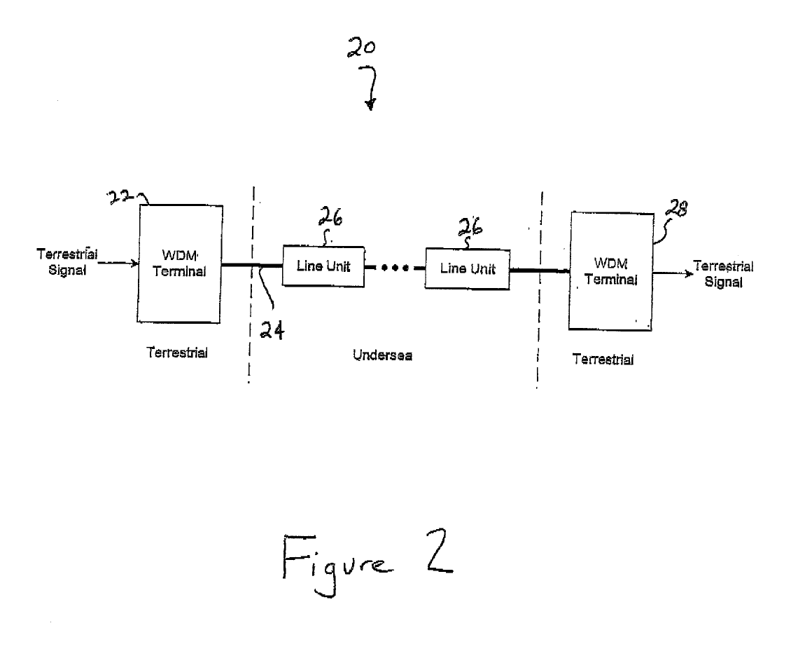

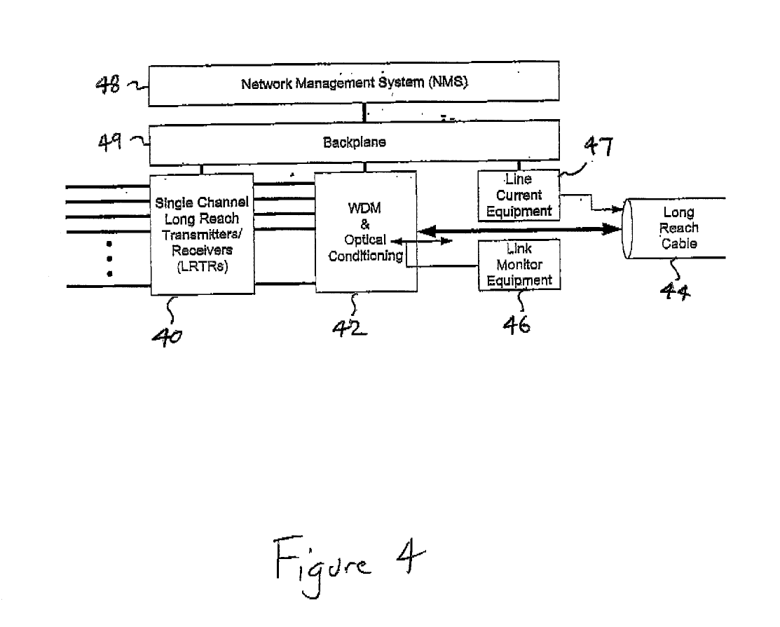

Initially, however, an exemplary Raman amplified optical communication system will be described for context. Referring again to the general block diagram of FIG. 2, an exemplary architecture for terminals 22 and 28 is provided in the block diagram of FIG. 4. Therein, the long reach transmitters/receivers (LRTRs) 40 convert terrestrial signals into an optical format for long haul transmission, convert the undersea optical signal back into its original terrestrial format and provide forward error correction. The WDM and optical conditioning unit 42 multiplexes and amplifies the optical signals in preparation for their transmission over cable 44 and, in the opposite direction, demultiplexes optical signals received from cable 44. The link monitor equipment 46 monitors the undersea optical signals and undersea equipment for proper operation. The line current equipment 47 provides power to the undersea line units 26. The network management system (NMS) 48 controls the operation of the other components in the WDM terminal, as well as sending commands to the line units 26 via the link monitor equipment 46, and is connected to the other components in the WDM terminal via backplane 49.

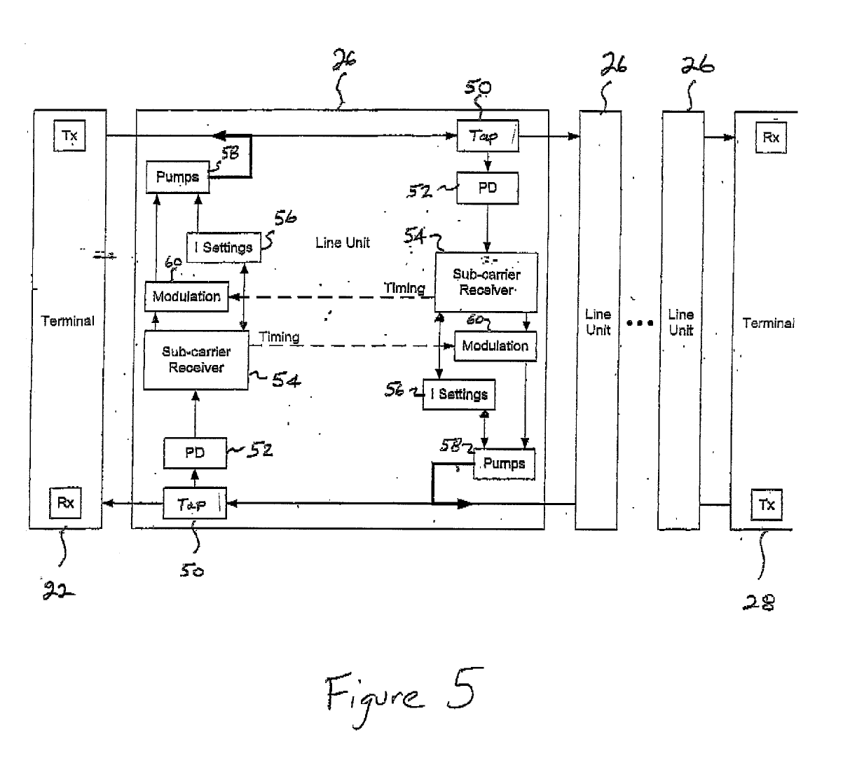

Functional blocks associated with an exemplary line unit 26 are depicted in FIG. 5. Therein, each fiber has a tap 50 connected thereto to sample part of the traveling WDM data signal. The taps 50 can, for example, be implemented as 2% tap couplers. A photodetector 52 receives the sampled optical signal from its respective tap 50 and transforms the optical signal into a corresponding electrical signal. The photodetector 52 outputs the electrical signal to a corresponding sub-carrier receiver unit 54, which detects and decodes the commands present in the sub-carrier modulated monitoring signal that has been modulated on the envelope of the WDM data signal. After decoding the command, the particular sub-carrier receiver 54 determines whether the decoded command is intended for it. If so, the action in the command is executed, e.g., measuring the power of the WDM signal, measuring the pump power output from one or more lasers in the pump assembly, or changing the supply current to the lasers of the pump assembly. To this end, the sub-carrier receivers 54 are connected to respective current control and power monitoring units (I settings) 56, which each include pump power monitors and pump current controls for each laser in the associated pump laser assembly 58.

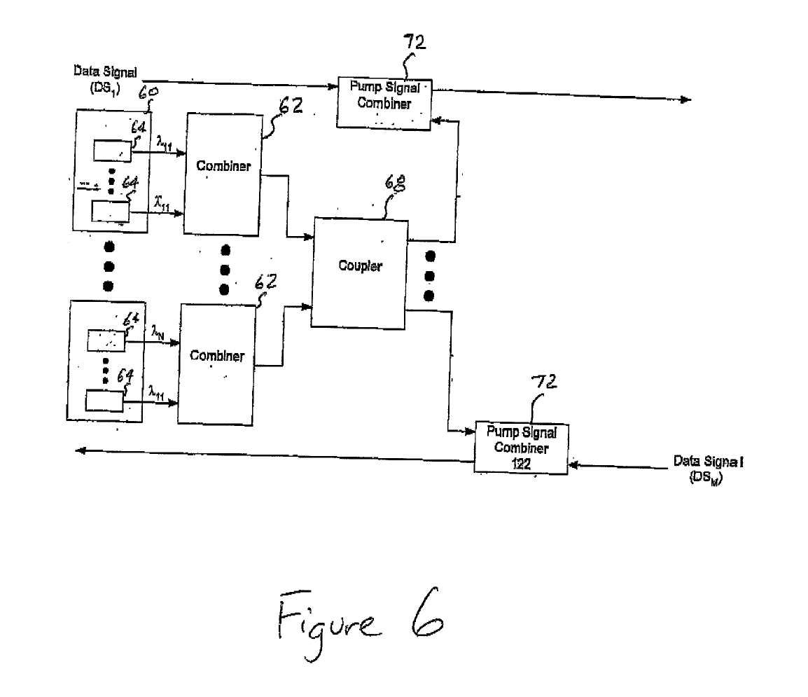

The pump modules 58 provide pump light into the optical fibers to amplify the data signals traveling therein using a Raman amplification scheme, as generally described above. The gain profile for a single pump wavelength has a typical bandwidth of about 20-30 nm. For high capacity WDM communication applications, such a bandwidth is too narrow and, accordingly, multiple pump wavelengths can be employed to broaden the gain profile. FIG. 6 depicts an exemplary pump architecture for providing multiple pump wavelengths in a Raman amplification scheme. Therein, a number N of pump radiation sources 60 are optically coupled to a respective one of N pump radiation combiners 62. Each of the pump radiation sources 60 generate various pump wavelengths at various pump powers using individual radiation emitters 64. The individual radiation emitters 64 can, for example, be lasers, light emitting diodes, fiber lasers, fiber coupled microchip lasers, or semiconductor lasers. The combiners 62 combine the various outputs of their respective pump radiation sources, e.g., by wave division multiplexing, and outputs the combined optical pumping signal to coupler 68. Coupler 68 can be an N×M coupler which takes contributions from all N inputs to provide a representative output at each of M output ports. Energy from the coupler 68 is pumped into the optical fiber(s) via pump signal combiners 72. In general, Raman pump architectures couple the light generated by pump lasers at various wavelengths and various powers to the optical fibers to pump the optical data signals. Those skilled in the art will appreciate that many other types of pumping architectures can be employed to provide Raman amplification to optical data signals in accordance with the present invention.

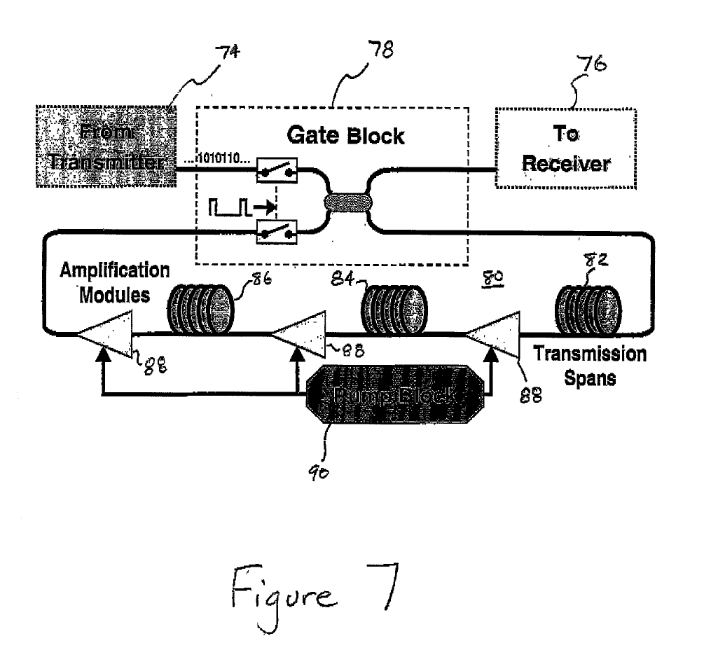

As mentioned above, Applicants have determined by experiment that Raman amplified systems are capable of transmitting WDM optical data signals over ultra-long haul distances without signal regeneration and, therefore, without the need to terminate the optical link at an intermediate point between the terminals 22 and 28. Specifically, Applicants performed a series of recirculating loop experiments which evidence this characteristic of Raman amplified WDM systems. As seen in FIG. 7, the recirculating loop includes a WDM transmitter 74 and receiver 76 connected to a gate block 78. The gate block 78 controls the operation of the recirculating loop to selectively perform WDM optical data signal injection by the transmitter 74, recirculation in the loop 80 to simulate ultra long-haul transmission and data acquisition by the receiver 76. In this particular experimental set-up, the recirculating loop included three transmission spans between which were placed Raman amplification modules 88. The Raman amplification modules 88 were fed pump radiation from pump block 90. Specific operating parameters of the recirculating loop experiment are provided in the table below.

| | |
|---|---|
| [0039] | Number of Channels |
| [0040] | 22 |
| [0041] | Channel Spacing |
| [0042] | 65 GHz between 1^{st} two channels; 60 |
| | GHz between 2^{nd} two channels; 45 GHz |
| | between remaining channels. |
| [0043] | Modulation Format |
| [0044] | Carrier Suppressed Return to Zero |
| | (CSRZ) |
| [0045] | Launch OSNR |
| [0046] | 27-30 dB |
| [0047] | Distance |
| [0048] | 13,000 km |
| [0049] | Net Loss Per Loop Trip |
| [0050] | 45 dB |
| [0051] | Span 82 |
| [0052] | 2x22.5 km True Wave ® reduced slope |
| | fiber |
| [0053] | Span 84 |
| [0054] | 2x22.5 km True Wave ® reduced slope |
| | fiber + 7 km dispersion compensating fiber |
| [0055] | Span 86 |
| [0056] | 2x22.5 km True Wave ® reduced slope |
| | fiber |
| [0057] | Pump Wavelengths |
| [0058] | 1420 nm, 1455 nm, 1480 nm |
| [0059] | Received OSNR |
| [0060] | ˜ 12 dB (0.1 nm resolution bandwidth) |
| [0061] | Bit Error Rate |
| [0062] | <1e−13 @ EOL with FEC |

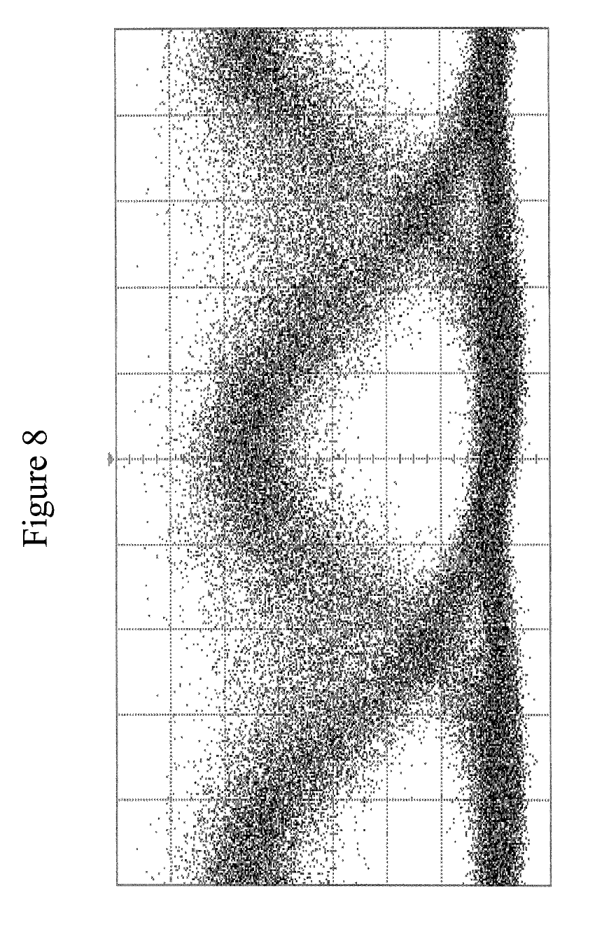

As seen in the last row of the table above, the results of the recirculating loop experiment, e.g., a measured bit error rate of less than 10-13 at the end of line measurement (using forward error correction coding), indicate that ultra long-haul Raman amplified WDM optical communication systems need not have their optical links terminated, which recognition will be used in configuring systems according to the present invention as described below. A so-called “eye” diagram, which is employed by those skilled in the art to provide a visual channel quality indication, for one of the WDM channels passed through the recirculating loop 80 is reproduced as FIG. 8. Therein, the relative openness of the eye will indicate to those skilled in the art the high quality of the received WDM signal, as compared with a signal that has suffered significant accumulation of non-linearity impairment.

One challenge associated with providing a wideband, Raman amplified, ultra long-haul optical communication system involves power feeding considerations. Line units in conventional, narrowband, EDFA systems consumed relatively little power. However, to provide each line unit 26 with enough power to drive a large number of pump lasers and associated circuitry will likely require a power feeding system that supplies more than 10,000 Watts and, possibly, as much as 80,000 Watts, depending upon the length of the system, number of fibers employed in the system (e.g., 2, 4, 6, 8, 16, etc.) and other factors. Those skilled in the art will appreciate the problems associated with manufacturing and deploying a 10-80 kW power cable in conjunction with more than 100 line units across, for example, the Pacific Ocean.

One method of ameliorating this problem is to dual feed the power cable with a positive voltage at a first end and a negative voltage at a second end. Thus, the approximate voltage at a midpoint of the power cable would be zero. This “dual fed” configuration carries half the voltage across any one section of the power cable, thereby increasing the maximum total power capacity of the power cable. This method of implementing a long-haul optical communication system reduces the power cable length by half, as each power cable only has to provide power for half the total communication distance between the first location and the second location. However, even dual fed power cables are may not be capable of carrying sufficient power (given cable diameter limitations) watts of total power over ultra long-haul distances.

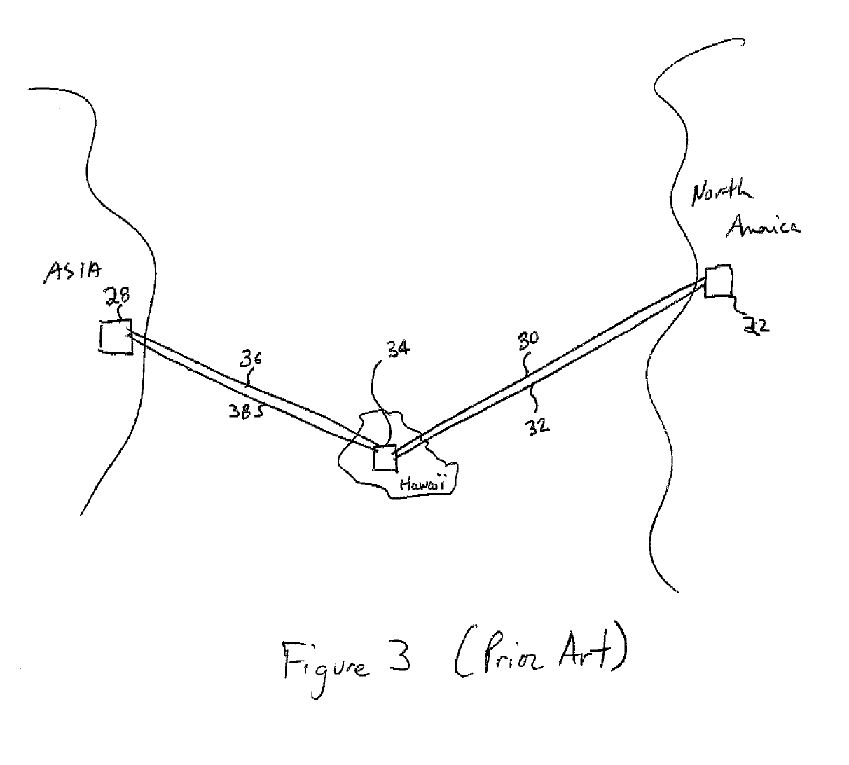

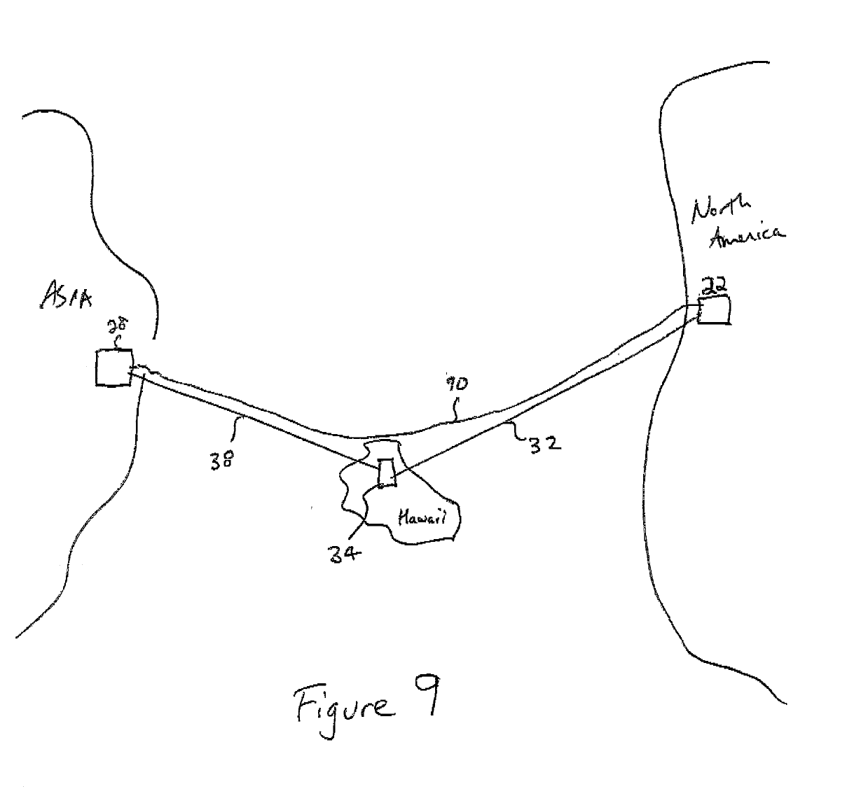

Accordingly, exemplary embodiments of the present invention provide for an ultra long-haul, Raman amplified, WDM optical communication system wherein the optical link is unterminated between terminals, but a power termination is provided. This is generally shown in FIG. 9, wherein the same reference numerals as in FIG. 3 are used to refer to like elements. Note that, unlike FIG. 3, optical link 90 is not optically terminated, but continues for the entire span between terminals 22 and 28. Exemplary systems which implement this approach are described below.

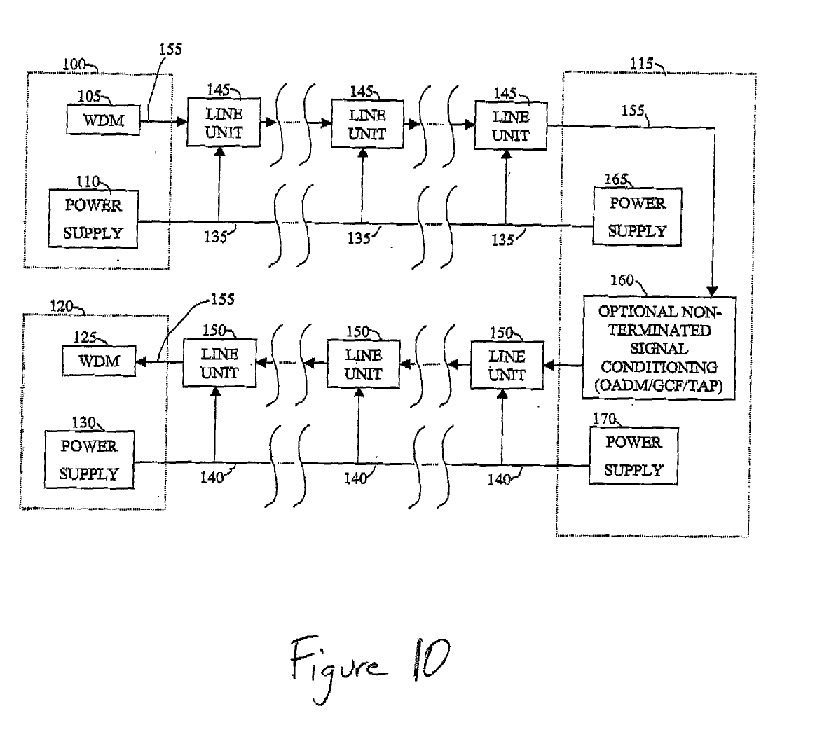

A first exemplary embodiment of an ultra long-haul optical communication system according to the present invention is shown by the block diagram of FIG. 10. A first location 100 (e.g., California) is shown transmitting to a second location 120 (e.g., China) via optical fiber 155. A site of power termination 115 (e.g., Hawaii) is located at a position between transmitting WDM 105 at a first end of the optical fiber 155, and receiving WDM 125 at a second end of the optical fiber 155. The site of power termination 115 is preferably located at about a midpoint of the optical fiber 155, although this site can also be located offset therefrom.

Power cables 135 and 140 are both terminated at the site of power termination 115. An exemplary power cable termination is the subject of U.S. Pat. No. 5,719,693, and is incorporated by reference herein in its entirety. Power supplies 110 and/or 165 supply power to power cable 135 for a first group of line units 145 that amplify an optical signal propagating along the optical fiber 155. Similarly, power supplies 130 and/or 170 supply power to power cable 140 for a second group of line units 150 that amplify the optical signal propagating along the optical fiber 155. Preferably, power supply 110 supplies a positive voltage to power cable 135, and power supply 165 supplies a negative voltage to power cable 135, such that power cable 135 is dual fed with power. More preferably, power supply 170 supplies a positive voltage to power cable 140, and power supply 130 supplies a negative voltage to power cable 140, such that power cable 140 is also dual fed with power. Optionally, power cables 135 and 140 may each be fed from only one end. Further, a single power cable may be provided to supply power to all of the line units 145 and 150, so long as it is terminated at the site of power termination 115.

As would be readily apparent to one skilled in the art, any number of line units 145 and 150 may be provided for optical signal amplification depending on the particular implementation. Thus, the number of line units 145 and 150 shown in FIG. 10 is exemplary only and is not limiting on the scope of the present invention.

A plurality of sites of power termination according to any of the embodiments of the present invention may be provided, so long as the sites of power termination are positioned between the first location and the second location. For example with reference to the first embodiment according to FIG. 10, a Trans-Pacific link between a first location 100 (e.g., California) and a second location 120 (e.g., Japan) may have a first site of power termination 115 (e.g., Hawaii), and a second site of power termination (e.g., Okinawa; not shown). Thus, the singular site of power termination 115 shown in FIG. 10 is exemplary only, and is not limiting on the scope of the present invention.

Although termination of the WDM optical signal is not desirable, optional signal conditioning equipment 160 which operates on the WDM optical signal without transforming it into the electrical domain may be implemented adjacent to the site of power termination 115. For example, a gain correction filter (GCF) may be implemented to adjust the gain profile of a WDM optical signal propagating along the optical fiber 155. Further, an optical signal tap may be implemented to monitor a WDM optical signal propagating along the optical fiber 155, such as monitoring for a loss of signal. Further, an optical add/drop multiplexer (OADM) may be implemented to filter out at least one channel of a WDM optical signal propagating along the optical fiber 155 and insert at least one other channel into the WDM optical signal propagating along the optical fiber 155. Other non-terminated signal conditioning equipment 160 may be implemented adjacent to the site of power termination 115 as would be readily apparent to one skilled in the art.

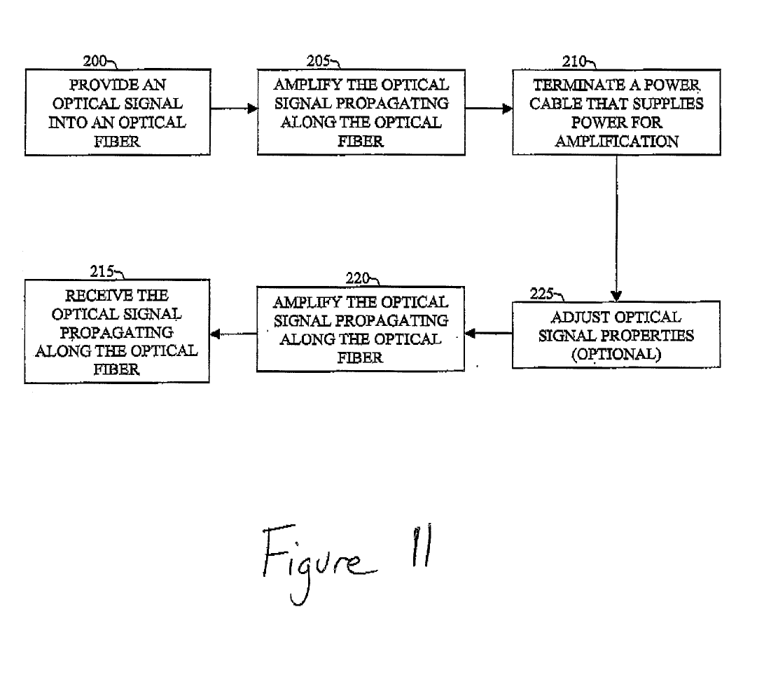

A second embodiment of a method of transmitting a WDM optical signal is shown by the block diagram of FIG. 11. A first location (e.g., California) provides a WDM optical signal into an optical fiber in step 200. The WDM optical signal propagating along the optical fiber is amplified in steps 205 and 220. A plurality of line units, for example, may amplify the WDM optical signal propagating along the optical fiber in any of the embodiments of the present invention. A power cable supplies power for amplification steps 205 and 220, and is terminated at a site of power termination (e.g. Hawaii) in step 210, preferably located at about a midpoint of the optical fiber. The WDM optical signal is received at a second location (e.g., China) in step 225, thereby completing the communication link between the first location and the second location.

Optionally, an additional step 225 of adjusting optical signal properties may be provided, such that the optical fiber is not terminated. For example, a GCF may be implemented to adjust the gain profile of an optical signal propagating along the optical fiber. Further, an optical signal tap may be implemented to monitor a WDM optical signal propagating along the optical fiber, such as monitoring for a loss of signal. Further, an OADM may be implemented to filter out at least one channel of a WDM optical signal propagating along the optical fiber and insert at least one other channel into the WDM optical signal propagating along the optical fiber. Other non-terminated optical signal adjustments may be implemented as would be readily apparent to one skilled in the art.

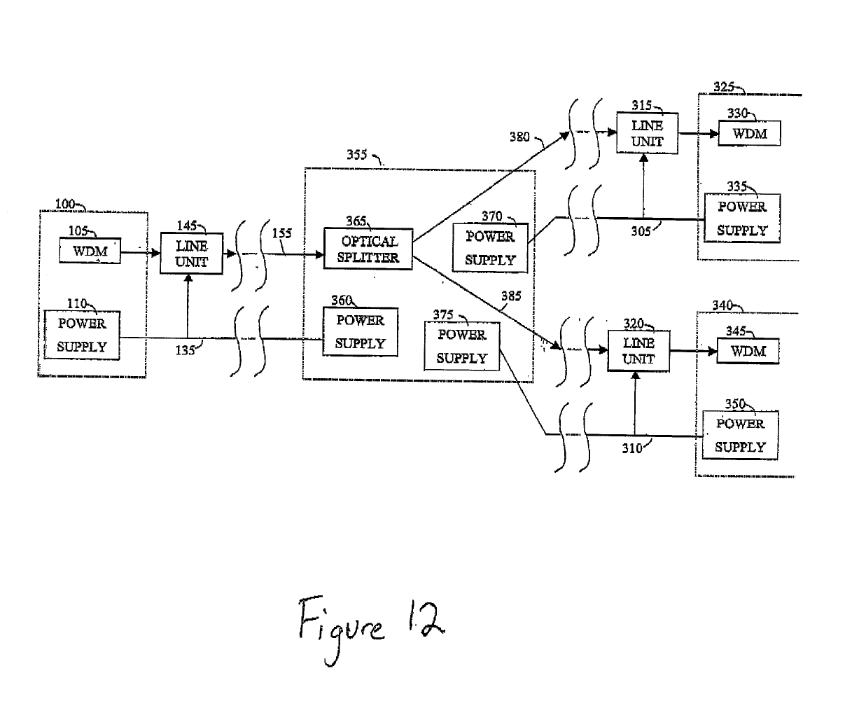

A third exemplary embodiment of an ultra long-haul optical communication network is shown by the block diagram of FIG. 12. This third embodiment is similar to the first embodiment, hence only the differences between the first and third embodiments will be described below.

According to this third embodiment, an optical splitter 365 may be provided adjacent to the site of power termination 355. The optical splitter 365 provides a WDM optical signal received on an input optically coupled to a first optical fiber 155 to a first optical branch path 380 and a second optical branch path 385.

Similar to a first embodiment of the present invention, WDM optical signals propagating along the optical branch paths 380 and 385 are amplified by at least one line unit. A WDM optical signal propagating along first optical branch path 380 is amplified by at least one line unit 315 and received by WDM 330. Power supplies 370 and/or 335 supply power via power cable 305 to the at least one line unit 315. Further, a WDM optical signal propagating along a second optical branch path 385 is amplified by at least one line unit 320 and received by WDM 345. Power supplies 375 and/or 350 supply power via power cable 310 to the at least one line unit 320.

According to this third embodiment, an optical communication system with a plurality of long-haul optical branch paths may be implemented to allow ultra long-haul optical communication between a plurality of links. By way of example, a first location 100 (e.g., California) may transmit WDM optical signals to a second location 325 (e.g., China) and a third location 340 (e.g., Japan). An optical splitter 365 may be positioned adjacent to a site of power termination 355 (e.g., Hawaii), to provide a WDM optical signal received from the first location 100 via optical fiber 155, to a first optical branch path 380 optically coupled to second location 315 and to a second optical branch path 385 optically coupled to third location 340. Any number of long-haul and/or ultra long-haul optical fiber links may be provided, allowing unprecedented communication bandwidth between a plurality of locations separated by great distances.

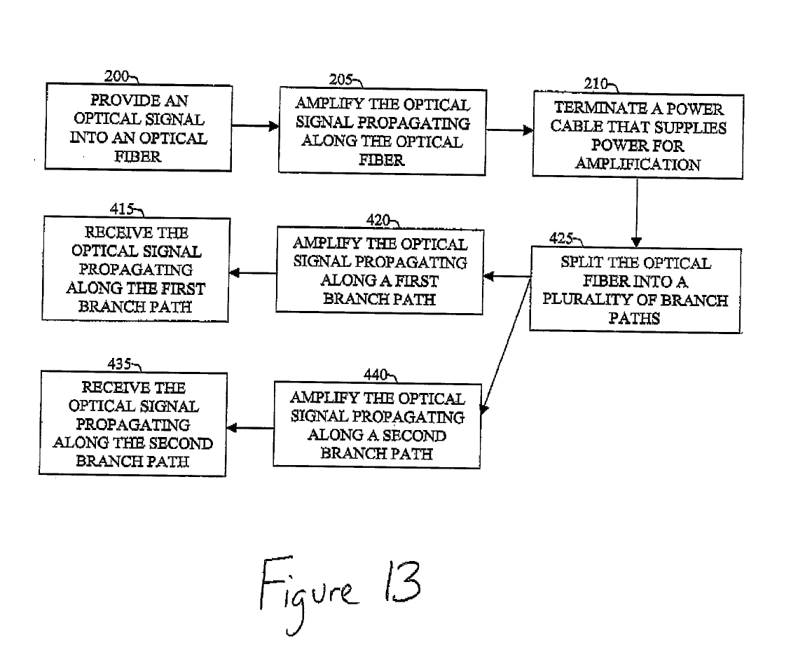

A fourth exemplary embodiment of a method of transmitting a WDM optical signal is shown by the block diagram of FIG. 13. This fourth embodiment is similar to the second embodiment, hence only the differences between the second and fourth embodiments will be described below.

According to this fourth embodiment, step 425 may be provided to provide a WDM optical signal received on an input optically coupled to a first optical fiber to a first optical branch path and a second optical branch path. An optical splitter, for example, may be provided at a location adjacent to a site of power termination to perform step 425. The WDM optical signals propagating along the first optical branch path and second optical branch path are amplified in steps 420 and 440 respectively, and received at a second location and a third location in steps 415 and 435 respectively. Similar to the third embodiment, any number of long-haul/ultra long-haul optical fiber links may be provided, allowing unprecedented communication bandwidth between a plurality of locations separated by great distances.

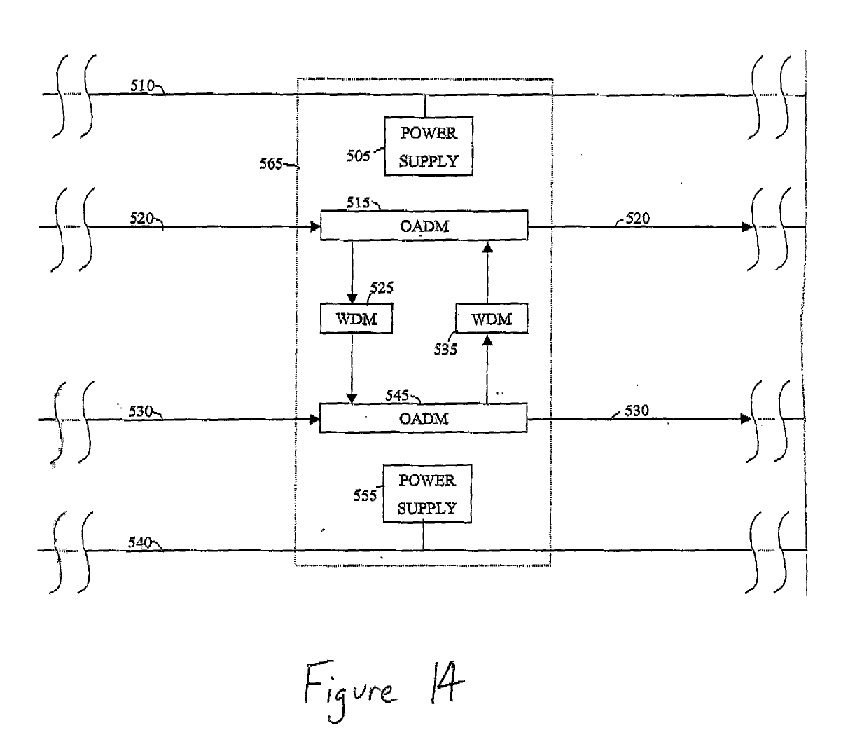

A fifth exemplary embodiment of an ultra long-haul WDM optical communication system is shown by the block diagram of FIG. 14. In this fifth embodiment, a first location (not shown) transmits to a second location (not shown) via optical fibers 520 and 530. Power cables 510 and 540 are terminated at site of power termination 565, located between a first end and a second end of optical fibers 520 and 530. Power cables 510 and 540 supply power to a plurality of line units (not shown) for amplifying WDM optical signals propagating via optical fibers 520 and 530 respectively. Power supplies 505 and 555 supply power to power cables 510 and 540 respectively. Optionally, one power supply may be provided to supply power to both power cables 510 and 540.

A WDM optical communication system according to this fifth embodiment allows for the insertion of individual channels into an optical fiber without having to terminate the optical fiber, thereby allowing new and/or modified channels to be inserted at the site of power termination 565. In this fifth embodiment, OADMs 515 and 545 each filter out at least one channel of a WDM optical signal propagating along optical fibers 520 and 530 respectively. WDMs 525 and 535 only terminate the channels filtered out by OADMs 515 and 545, and insert a corresponding number of new and/or modified channels back into OADMs 515 and 545.

An optical communication system according to this fifth embodiment thus provides the benefits of allowing termination of at least one channel, without having to terminate the entire optical fiber as done in conventional optical communication systems. Channel termination allows an optical communication system to be customized based on the particular implementation, which allows a designer to weigh the cost of additional WDM equipment on a per channel basis versus the minimum number of terminated channels required.

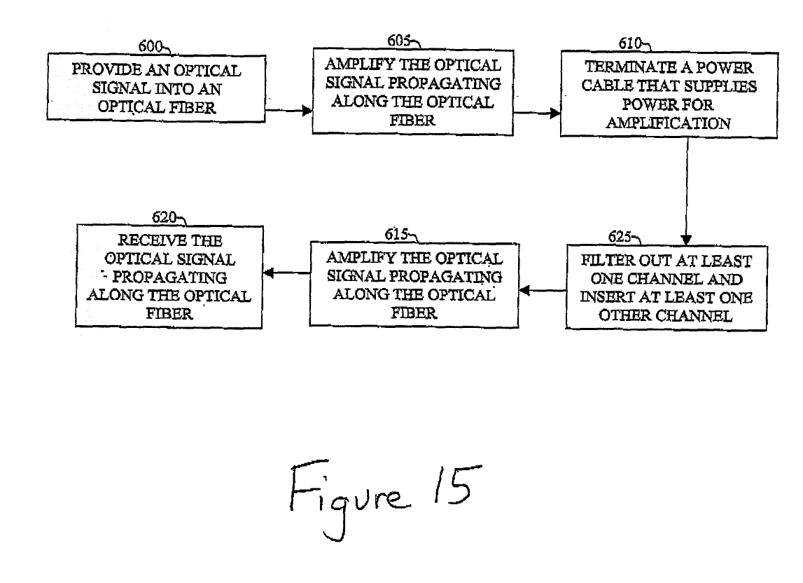

A sixth exemplary embodiment of a method of transmitting a WDM optical signal is shown by the block diagram of FIG. 15. In this sixth embodiment, a first location provides a WDM optical signal into an optical fiber in step 600. The WDM optical signal propagating along the optical fiber is amplified in steps 605 and 615. A power cable supplies power for amplification steps 605 and 615, and is terminated in step 610 at a position between a first location that provides the WDM optical signal into an optical fiber in step 600 and a second location that received the WDM optical signal propagating along the optical fiber in step 620. Step 625 filters out at least one channel from the WDM optical signal propagating along the optical fiber, and inserts at least one new channel into the WDM optical signal propagating along the optical fiber. Step 625 may be performed, for example, by an OADM positioned adjacent to a site of power termination. Similar to a fifth embodiment, a method of transmitting an optical signal according to this sixth embodiment thus provides the benefits of allowing termination of at least one channel, without having to terminate the entire optical fiber as done in conventional methods of transmitting a WDM optical signal.

Thus, an optical communication system having a power cable terminated between a first end and a second end of an optical fiber has been described according to the present invention. As would be readily apparent to one skilled in the art, the aforementioned embodiments may be combined in various configurations based on the particular optical communication system required. For example, the land segment of the system on which the power termination occurs may also include a number of terrestrial amplifiers which amplify the signal as it travels through the optical fibers over land. These terrestrial amplifiers may have their own source of power, i.e., may not be powered by the power cable associated with the submarine portion of the system. Many other modifications and variations may be made to the techniques and structures described and illustrated herein without departing from the spirit and scope of the invention. Accordingly, it should be understood that the methods and apparatus described herein are illustrative only and are not limiting upon the scope of the invention.

What is claimed is:

1. A method of transmitting a wave division multiplexed (WDM) optical signal, comprising the steps of:
providing a WDM optical signal into an optical fiber having a first end and a second end;
amplifying the WDM optical signal propagating along the optical fiber; and
supplying power for amplification from a power cable having at least one end terminated between the first end and the second end of the optical fiber.

2. The method of claim 1, wherein the power cable length is less than the total length of the optical fiber.

3. The method of claim 1, wherein the power cable is terminated at about a midpoint of the optical fiber.

4. The method of claim 1, wherein a first end of the power cable is connected to a positive voltage supply and a second end of the power cable is connected to a negative voltage supply.

5. The method of claim 1, wherein the step of supplying power for amplification supplies at least 10,000 watts of total power for amplification.

6. The method of claim 1, wherein the optical fiber is at least 9000 km in length.

7. The method of claim 1, further comprising a step of monitoring optical signal quality of the WDM optical signal propagating along the optical fiber at a site of power termination.

8. The method of claim 1, further comprising a step of adjusting a gain profile of the WDM optical signal propagating along the optical fiber at a site of power termination.

9. The method of claim 1, further comprising the steps of:
filtering out at least one channel and fewer than all channels of the WDM optical signal propagating along the optical fiber; and
inserting at least one other channel of the WDM optical signal propagating along the optical fiber,
wherein the steps of filtering out at least one channel and inserting at least one other channel are performed at a site of power termination.

10. The method of claim 1, further comprising a step of splitting the optical fiber into a first branch path and a second branch path at a site of power termination.

11. The method of claim 1, wherein the step of amplifying the WDM optical signal propagating along the optical fiber is performed by at least one Raman amplifier.

12. The method of claim 1, wherein the step of supplying power for amplification supplies power to only one end of the power cable.

13. A method of providing power via a power cable to optical line units for amplification of a WDM optical signal propagating along an optical fiber comprising the steps of:
providing said optical fiber having a first end and a second end, said fiber being optically terminated solely at the first end and the second end; and
terminating at least one end of the power cable between a first plurality of line units and a second plurality of line units connected to said optical fiber and said power cable.

14. The method of claim 13, wherein the power cable length is less than the total length of the optical fiber.

15. The method of claim 13, further comprising the step of launching a WDM optical signal into the optical fiber.

16. The method of claim 15, further comprising the step of monitoring quality of the WDM optical signal at a site of power termination.

17. The method of claim 15, further comprising a step of adjusting a gain profile of the WDM optical signal at a site of power termination.

18 The method of claim 15, further comprising the steps of:
filtering out at least one channel and fewer than all channels of the WDM optical signal; and
inserting at least one other channel of the WDM optical signal,
wherein the steps of filtering out at least one channel and inserting at least one other channel are performed at a site of power termination.

19. The method of claim 13, wherein the line units comprise Raman amplifiers.

20. A method of transmitting a wave division multiplexed (WDM) optical signal via an optical fiber having a first end and a second end, comprising the steps of:
providing a WDM optical signal into a long-haul optical fiber terminated solely at a first end and a second end;
amplifying the WDM optical signal propagating along the optical fiber in a plurality of line units; and
supplying power for amplification via a power cable to the plurality of line units,
wherein the power cable is positioned adjacent to the optical fiber,
wherein the power cable is connected to the line units, and
wherein the power cable is terminated at a site of power termination located between the first end and the second end of the optical fiber.

21. The method of claim 20, wherein the power cable supplies at least 10,000 watts of power to the line units.

22. The method of claim 20, wherein the line units comprise Raman amplifiers.
